(19) United States
(12) Patent Application Publication
(10) Pub. No.: US 2015/0312399 A1
(43) Pub. Date: Oct. 29, 2015

(54) FLASHLIGHT AND DEFENSIVE SPRAY APPARATUS WITH INTEGRAL LOCATOR TRANSMITTAL DEVICE

(71) Applicant: Michael Teig, Heber City, UT (US)

(72) Inventor: Michael Teig, Heber City, UT (US)

(21) Appl. No.: 14/696,363

(22) Filed: Apr. 24, 2015

Related U.S. Application Data
(60) Provisional application No. 61/983,650, filed on Apr. 24, 2014.

(51) Int. Cl. H04M 1/725; H04W 4/02; H04W 4/22; F41H 9/10; F21V 33/00

(52) U.S. Cl. CPC H04M 1/72541; F41H 9/10; F21V 33/0076; H04W 4/22; H04W 4/023; H04M 1/72572

(57) ABSTRACT

A self defense apparatus comprising a body containing a light source, a container that contains a defensive spray material, and a wireless device programmed to transmit message data to a first remote device, and activation structure that activates the light source to produce a light, the defensive spray material to exit the container, and the wireless device to transmit the message data.

This application claims priority on a US provisional patent application filed on Apr. 24, 2014, and assigned Ser. No. 61/983,650, entitled FLASHLIGHT AND DEFENSIVE SPRAY APPARATUS WITH INTEGRAL LOCATOR TRANSMITTAL DEVICE, in the name of inventor Michael H. Teig, which application is hereby incorporated herein in its entirety.

### TECHNICAL FIELD

The present invention relates to a flashlight and defensive spray apparatus, such as a flashlight and pepper spray combination apparatus. The apparatus includes activation buttons for both the flashlight and the defensive spray component in close proximity to one another so as to facilitate activation of both components by a single thumb or finger of the operator, which may be desirable in emergency situations. The present invention may also include a locator transmittal device so as to alert a predetermined entity that an alarm on the device has been activated while simultaneously transmitting the global location of the device when the alarm was activated. The location device may be activated simultaneously with activation of the pepper spray device.

### BACKGROUND OF THE INVENTION

The present invention is particularly intended for use in situations where use of a flashlight, a defensive spray device, and a locator transmittal device may each be desirable, such as by police and/or military personal, and such as by civilians in self defense situations. In previous situations, a flashlight and a pepper spray device may each be carried separately by police and/or military personnel, or by civilians in self defense situations. In some prior art devices, a flashlight and a defensive spray component may be integrated into a single device. However, these devices generally include activation buttons positioned on opposite ends of the device, which makes simultaneous activation of the two components impractible or at least difficult. Such prior art devices, therefore, may not provide the effective and efficient defensive action required in emergency situations. There are also location transmittal devices in use, such as GPS devices in cars and the like. There is a need for a device that may allow activation of the multiple components simultaneously, and preferably, which allows for activation of a defensive spray, an intense light beam, and transmittal of a global location of the defensive spray device, by use of a single thumb or finger of the operator.

### SUMMARY OF THE INVENTION

The present invention provides a flashlight, defensive spray apparatus, such as a flashlight and pepper spray combination apparatus, together with a location transmittal device in a single hand held component. The apparatus includes activation buttons for the flashlight, the defensive spray component, and the location transmittal device, in close proximity to one another, or combined as a single activation button, so as to facilitate activation of both components by a single thumb or finger of the operator, which may be desirable in emergency situations. In particular, the activation buttons may be positioned next to each other, or connected to a single activation button, in an arrangement such that a single thumb of an operator may activate or deactivate both buttons, or the single button, without complicated finger movements. This time efficient and effective connected activation arrangement of the separate components of the present device may mean the difference between life and death for the operator in hostile situations.

### BRIEF DESCRIPTION OF THE DRAWINGS

FIG. 1 is a front isometric view of one example embodiment of a flashlight spray apparatus.

FIG. 2 is a front view of the apparatus of FIG. 1.

FIG. 3 is a back view of the apparatus of FIG. 1.

FIG. 4 is a side view of the apparatus of FIG. 1.

FIG. 5 is an exploded side view of the apparatus of FIG. 1.

FIG. 6 is a detailed cross-sectional side view of the apparatus of FIG. 1.

FIG. 7 is a front isometric view of a second example embodiment of a flashlight spray apparatus.

FIG. 8 is a back view of the apparatus of FIG. 7.

FIG. 9 is a detailed cross-sectional side view of another example embodiment of a flashlight spray apparatus.

FIG. 10 is a detailed cross-sectional side view of yet another example embodiment of a flashlight spray apparatus.

FIG. 11 is a detailed cross-sectional side view of an example embodiment of a flashlight spray apparatus including a location transmittal device.

FIG. 12 is a schematic drawing showing communication between, for example, the self defense transmittal device, the operator's cellular telephone, and other predetermined cellular telephones or receiving devices.

### DETAILED DESCRIPTION OF THE PREFERRED EMBODIMENTS

The invention discloses a combination flashlight, defensive spray device and location transmittal device, that may include one activation button arranged to allow simultaneous activation, by movement of a single thumb of an operator, of multiple components of the system.

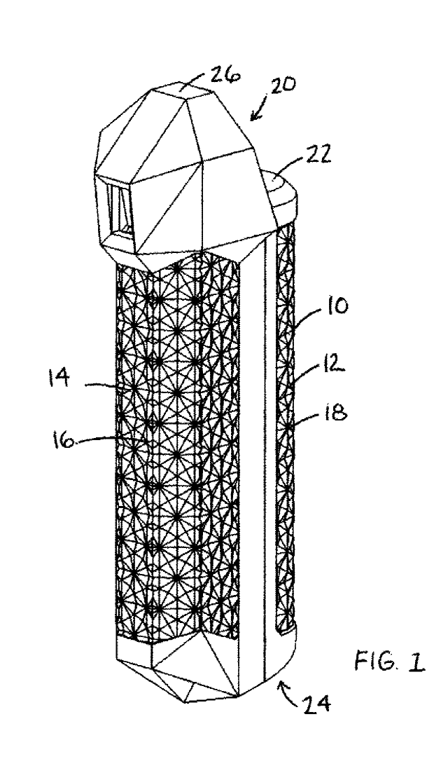

FIG. 1 is a front isometric view of a first example embodiment of a flashlight spray apparatus 10. The flashlight/pepper spray combination apparatus 10 incorporates a self-defense flashlight 12 with concealed chemical self-defense spray 14. The spray canister 16 is positioned parallel to the battery compartment 18 of the flashlight with the actuator 20 of the spray being positioned parallel to and slightly above the light switch 22. The light switch 22 is an “end switch” and is positioned on the butt end off the flashlight, opposite the end where the LED 24 is located. Both the spray switch 20 and the light switch 22 are operated with a single thumb of the operator.

The spray actuator 20 is located behind and slightly above the button 22 on the light and is accessed by inserting the thumb over the top of the light switch and resting it on the spray button 20 or “actuator.” The relationship of the spray actuator 20 and the lights multi-mode switch button 22, as well as the actuation pressure of each, has been designed to allow the operator to either move his thumb easily from one button to the other or the operator (user) can position his thumb on the spray actuator to enable an immediate self-defense response without having to move his thumb. Thus the thumb can be kept in the spray position while still being able to operate the multi-mode light button 22 by simply arching his thumb but not moving it from its position above the spray actuator 20. This simple action causes or allows the upper knuckle of the thumb to press down on the light button without applying pressure on the spray button.

A hood 26 over the spray button 20 is designed to prevent accidental or unintentional actuation of the spray by foreign objects. Additionally, a safety tab can be inserted under the actuator between the actuator button 20 and the top of the canister to prevent actuation while not in use.

The light function provides a unique sequencing feature with a “panic” mode that, regardless of the last mode the light was in, when initially turned on, it assumes a threat and goes into a high intensity blinding strobe designed to surprise and disorient the attacker. The user can bypass the panic mode and go to constant high beam by pushing the switch 22 down twice within approximately one-second. This can be done whether in momentary or click mode. In momentary mode, the user only has to push the button 22 partially down without clicking it. If left in that position for more that a second, it will go off when released. If left in that position for less than a second and pushed down again, partially or all the way, it will go to the next mode. There are four modes that include panic strobe, High, Low and SOS.

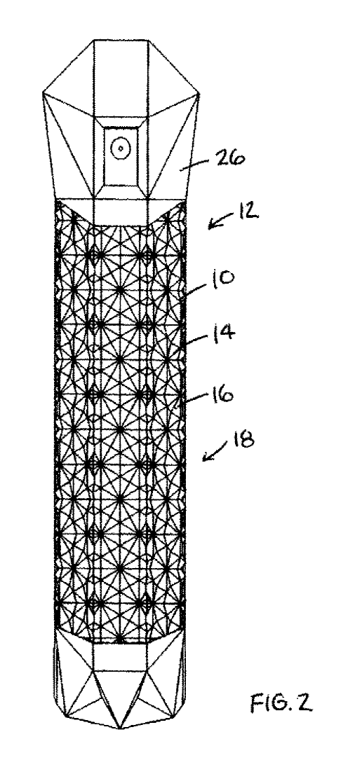

FIG. 2 is a front view of apparatus 10 of FIG. 1.

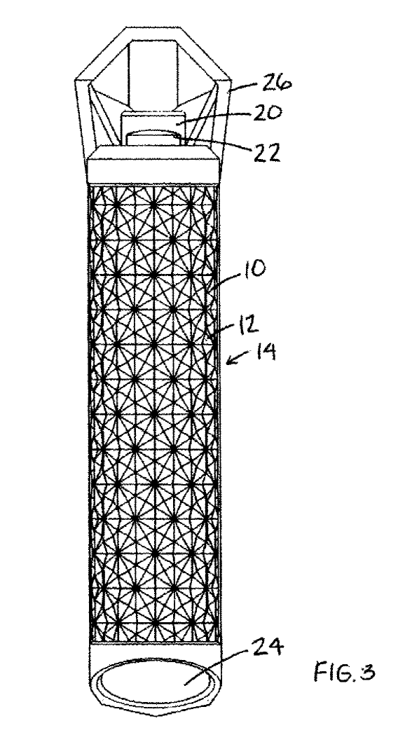

FIG. 3 is a back view of apparatus 10 of FIG. 1.

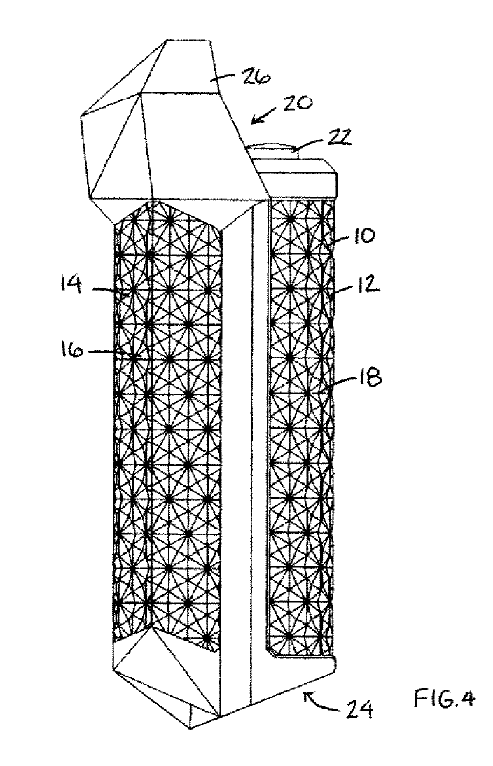

FIG. 4 is a side view of apparatus 10 of FIG. 1.

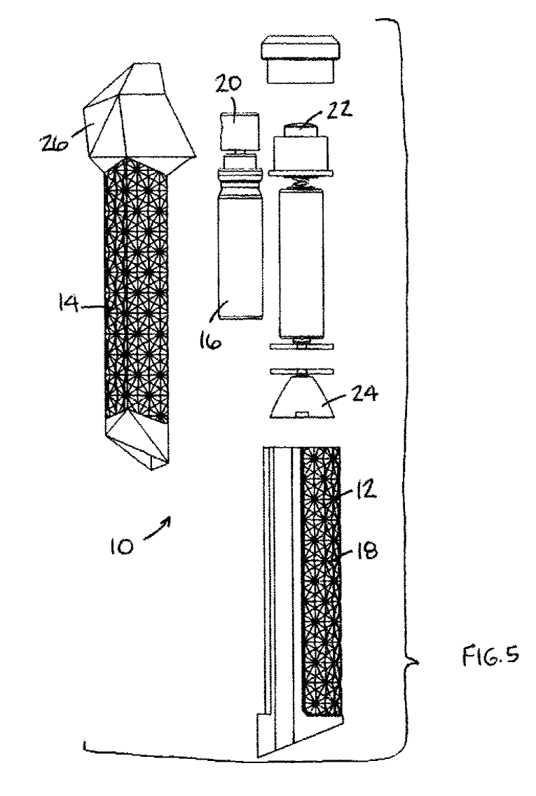

FIG. 5 is an exploded side view of apparatus 10 of FIG. 1.

FIG. 6 is a detailed cross-sectional side view of apparatus 10 of FIG. 1.

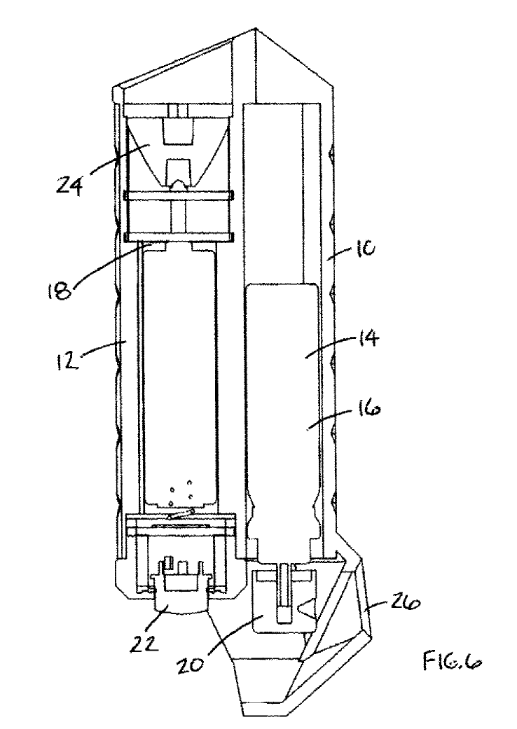

FIG. 7 is a front isometric view of a second example embodiment of a flashlight spray apparatus 10. In this embodiment the shape of the outer casing of apparatus 10 is slightly modified from the embodiment shown in FIG. 1. The functional parts of the apparatus remain the same as in FIG. 1, however, this embodiment includes a more rounded, less angular external design.

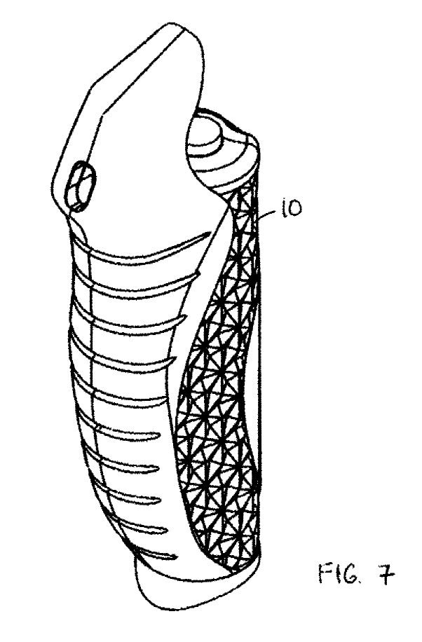

FIG. 8 is a back view of the apparatus of FIG. 7.

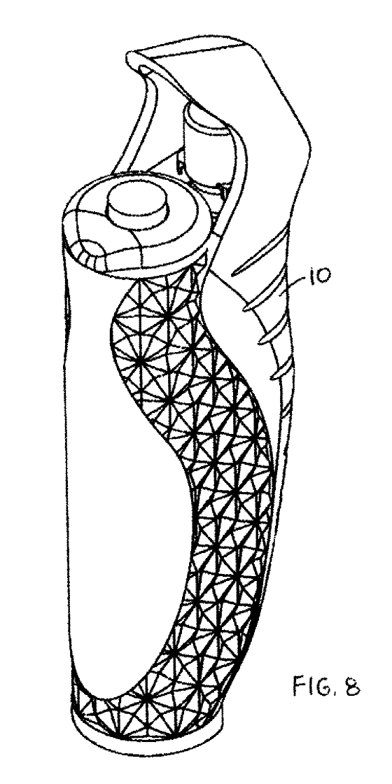

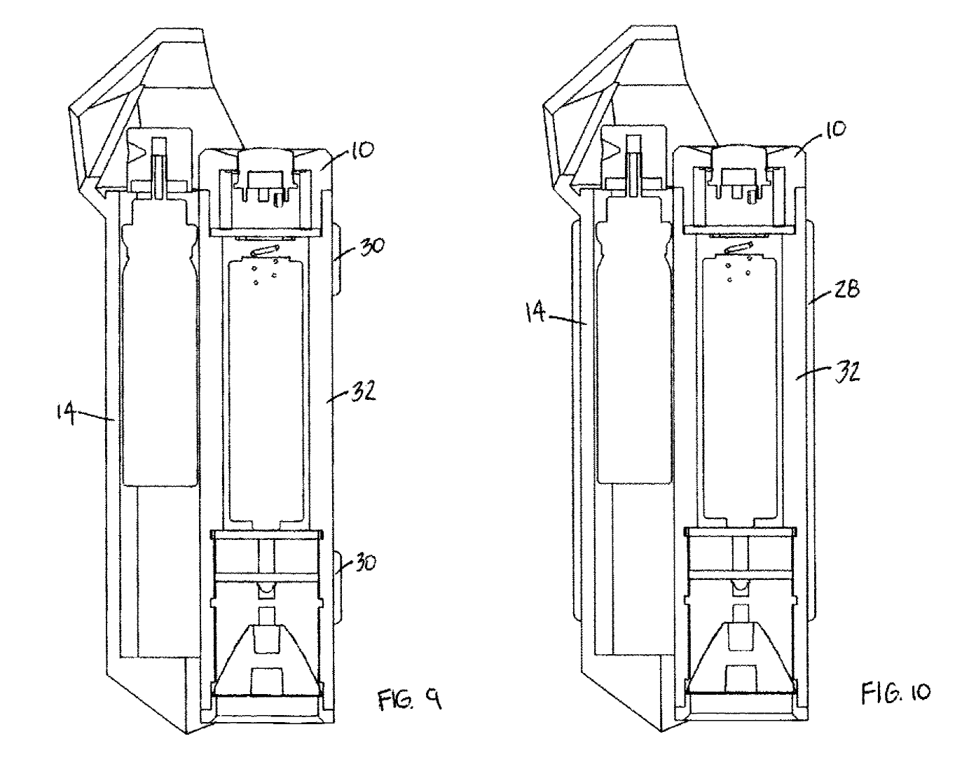

FIG. 9 is a detailed cross-sectional side view of another example embodiment of a flashlight spray apparatus 10. This third embodiment uses either a sleeve 28 (FIG. 10) or two strap-like fasteners 30 (FIG. 9) to secure the pepper spray portion 14 of the apparatus 10 to a variety of third party flashlights 32 that may vary slightly in size but are close to the size of the flashlight compartment 12 in the apparatus shown in FIGS. 1 and 2. This is done by using either a rubber sleeve 28, or bands 30, that slips over the pepper spray portion which houses the pepper spray and the pepper spray actuator, and secures it to the third party flashlight, holding them securely together in a position that the combination may be used essentially the same as the apparatus shown in FIGS. 1 and 2. The two fasteners 28 and/or 30 may be made of a variety of materials including plastic, rubber, leather, vinyl or any other material that may effectively secure the pepper spray compartment 16 to the third party flashlight 32.

FIG. 10 is a detailed cross-sectional side view of yet another example embodiment of a flashlight spray apparatus utilizing a sleeve 28.

Because the embodiments shown in FIGS. 9 and 10 utilize a typical tactical flashlight design with an end switch rather than a side switch and add the elements necessary to convert it to a self-defense device with concealed pepper spray or other chemical agents, it is adaptable to all similar lights and will be manufactured and sold also as a modification to other tactical lights to convert them to the type of apparatus shown in FIG. 1.

FIG. 11 is a detailed cross-sectional side view of an example embodiment of a flashlight spray apparatus including a location transmittal device. In this embodiment, self defense apparatus 10 includes a canister 16 of spray material 14 housed within apparatus 10 as well as a flashlight 24. Apparatus 10 may further include a location transmittal device 32 connected to actuator button 20 by a connection device 34, such as a wire.

Activation of button 20, such as depressing button 20 with the user's thumb, will simultaneously activate spray canister 16 to discharge spray 14, such as pepper spray, toward an assailant, and activate location transmittal device 32 to send a wireless communication from apparatus 10. Location transmittal device 32 may comprise a Bluetooth device, such as an iBeaon device manufactured by Apple, which may be compatible with Gimbal device manufactured by Qualcomm. Location transmittal device 32 may also include a global positioning system (GPS) that accurately assesses the particular global position of apparatus 10 when button 20 is depressed. This global position of apparatus 10 is transmitted by transmittal device 32 when button 20 is activated.

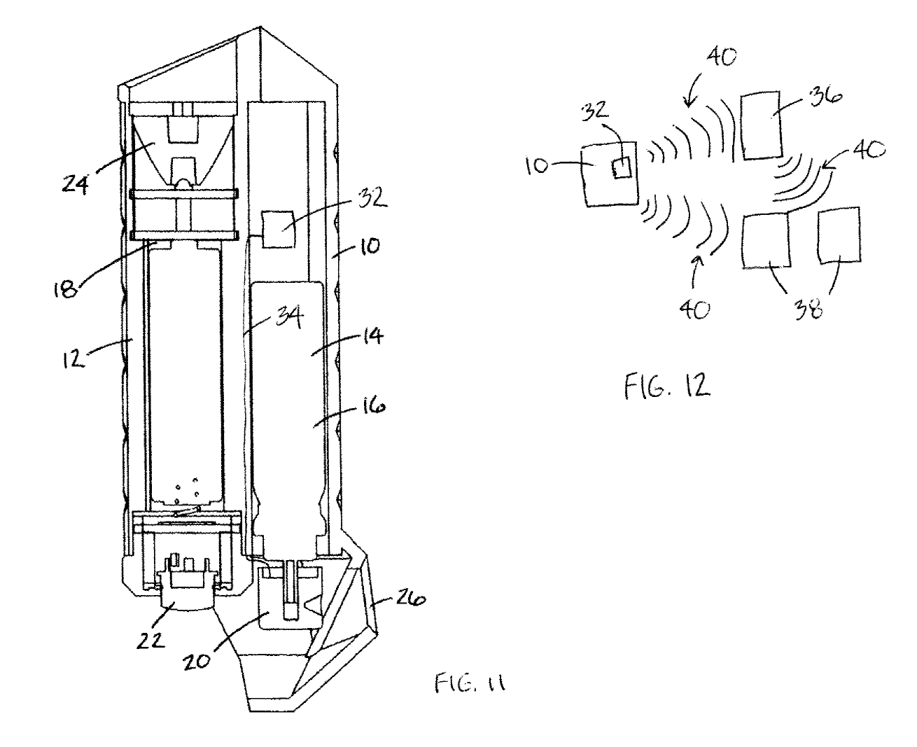

FIG. 12 is a schematic drawing showing communication between the self defense transmittal device 10, an operator's cellular telephone 36, and other predetermined cellular telephones or receiving devices 38. Use of the apparatus 10 will now be described. During an attack situation of a user carrying apparatus 10, the user will point apparatus 10 at an assailant and depress actuator button 20 to spray the assailant with pepper spray 14. Simultaneous with release of spray 14 at the assailant, activation button 20 activates location device 32 to assess the exact global location of apparatus 10 using wireless global positioning information. Device 32 then transmits a “spray alert” message, or another predetermined message, from apparatus 10 to the user's telephone 36 and/or other receiving devices 38.

In one example, device 32 may transmit a wireless message 40 to the user's cellular telephone 36 which in turn then retransmits the spray alert message 40 to one or more predetermined receiving devices 38, such as to the nearest police and/or fire station, to the computer or telephone of friends and/or family of the user, and to any other communication receiving devices, such as cellular telephones, in close proximity to apparatus 10 when activated. In another embodiment device 32 may transmit a spray alert message 40 directly to communication receiving devices 38, such as cellular telephones in close proximity to apparatus 10 when activated.

The spray alert message may include any information as desired, such as a message previously input and saved within device 32 or within the user's cellular telephone 36, by the user, together with the global positioning information determined by device 32 at the time of activation. One example spray alert message may include the individualized portion “Spray alert notification from Jane Doe! (999) 123-4567” together with global positioning information, such as “1234 North Main Street, Anytown, USA 12345.” Such a spray alert message allows help from individuals in close proximity to the activation location, while simultaneously alerting the nearest police department of the situation. Moreover, the spray alert message may transmit the telephone number of the user so that police may contact the user for more information if the user has run from the attack location. Accordingly, the spray alert message may allow the police to contact the user to verify the user is safe, and to gather information which may be necessary for prosecution of the assailant. This spray alert message is transmitted simultaneously with release of pepper spray at the assailant, thereby allowing the user to simultaneously defend themselves and alert potential help to come to their aid.

In the above description numerous details have been set forth in order to provide a more through understanding of the present invention. It will be obvious, however, to one skilled in the art that the present invention may be practiced using other equivalent designs.

I claim:

1. A self defense apparatus, comprising:
a body containing a light source, a container that contains a defensive spray material, and a wireless device programmed to transmit message data to a first remote device; and
activation structure that activates said light source to produce a light, said defensive spray material to exit said container, and said wireless device to transmit said message data.

2. The apparatus of claim 1 wherein said activation structure comprises a first activation device for said light source, and a second, single activation device for said defensive spray and said wireless device.

3. The apparatus of claim 2 wherein said first and second activation devices are positioned adjacent one another.

4. The apparatus of claim 1 wherein said first remote device comprises a predetermined wireless cellular telephone.

5. The apparatus of claim 4 further comprising a computer application stored in said predetermined wireless cellular telephone, said computer application transmitting said message data from said predetermined cellular telephone to a second remote device.

6. The apparatus of claim 5 wherein said second remote device comprises a plurality of area cellular telephones positioned within a predetermined radius surrounding said apparatus when said message data is transmitted, wherein a presence of said plurality of area cellular telephones within said predetermined radius is determined by said wireless device utilizing global positioning system data.

7. The apparatus of claim 6 wherein said message data comprises location data specifying the geographic location of said apparatus when said message data is transmitted, said location data determined by said wireless device from global positioning system data.

8. The apparatus of claim 7 wherein said message data further comprises identifying data input to said wireless device by an operator.

9. The apparatus of claim 8 wherein said identifying data includes operator name, operator photograph, operator address, and operator cellular telephone number.

10. The apparatus of claim 5 wherein said second remote device comprises a plurality of known information devices wherein a number of each of said plurality of known information devices is programmed into said wireless device prior to transmission of said message data, said information devices chosen from wireless telephones, landline telephones, desktop computers, laptop computers, and handheld wireless devices.

11. The apparatus of claim 7 wherein said message data includes a distress message requesting assistance at said geographic location of said apparatus when said message data is transmitted.

12. The apparatus of claim 5 wherein said second remote device comprises a plurality of first responders within a predetermined radius surrounding said apparatus when said message data is transmitted, said first responders chosen from the group consisting of a fire station, a police station, and a paid security service.
